(19) United States
(12) Patent Application Publication
(10) Pub. No.: US 2010/0189166 A1
(43) Pub. Date: Jul. 29, 2010

(54) RECONFIGURABLE CIRCUIT, RECONFIGURABLE CIRCUIT FUNCTION MODIFICATION METHOD, AND COMMUNICATION DEVICE

(76) Inventor: Atsuhiro Mori, Osaka (JP)

Correspondence Address: MCDERMOTT WILL & EMERY LLP, 600 13TH STREET, NW, WASHINGTON, DC, 20005-3096, US

(21) Appl. No.: 12/677,658

(22) PCT Filed: Nov. 4, 2008
(86) PCT No.: PCT/JP2008/003156

§ 371 Date: Mar. 11, 2010

(30) Foreign Application Priority Data
Nov. 21, 2007 (JP) 2007-301305

(51) Int. Cl. H04L 5/16; G06F 12/00; G06F 9/00

(52) U.S. Cl. 375/219; 711/154; 711/E12.001; 713/100

(57) ABSTRACT

A reconfigurable circuit has a plurality of calculation elements including a first calculation element and a second calculation element. The first calculation element has a first configuration memory for storing first configuration data. Output data of the first configuration memory is inputted to the second calculation element. A predetermined bit in the first configuration data is updated by using the second calculation element so as to modify the function of the first calculation element. The time required for testing the reconfigurable circuit is consequently reduced.

### FIELD OF THE INVENTION

The present invention relates to a reconfigurable circuit comprising a plurality of programmable calculation elements disposed in row and column directions, and a method for modifying functions of the reconfigurable circuit.

### BACKGROUND OF THE INVENTION

Today, the needs of information processing in information processing terminals are diversified and standards for communication methods and signal processing are rapidly changing. Product life cycles, therefore, tend to become increasingly shorter under the circumstances. To cope with the increasingly shorter product lifecycles, a device whose functions can be modified by a program is useful. An example of such devices which have attracted attention is a reconfigurable circuit whose circuit architecture can be flexibly modified by a program. A reconfigurable circuit is a device having both a processing performance comparable to that of ASIC (Application Specific Integrated Circuit) and a programmability equivalent to that of a microprocessor. There are several types of reconfigurable circuits, typical examples of which are FPGA (Field Programmable Gate Array) and dynamic reconfigurable LSI.

When these reconfigurable circuits are tested to check all of their functions, it is necessary to subject the reconfigurable circuits to configuration (to configure a circuit to be programmable by storing circuit information into, for example, FPGA) before each of the tests for each of their functions to be tested so that the feasibility of the targeted functions is confirmed. Thus, it is necessary to repeatedly subject the reconfigurable circuit to the configuration for each of its functions, which increases costs and testing time.

Patent Document 1 discloses a method for controlling the increase of the testing time. This document recites an interconnect test method in PLD (programmable logic device) wherein wiring between logic elements (interconnect lines) is driven by programmable buffers. The programmable buffer comprises one memory element. When the interconnect lines are tested, circuits are subjected to configuration in such a way shift registers are constituted using the memory element, and then the buffers and the interconnect line which are subject to the test are inserted between two of these shift registers. Then, for signal transmission in the shift register, a test is conducted using a first test pattern. After the test is completed, a next test is conducted using other buffer and interconnect line. At that time, the whole PLD is not subjected to configuration, but partial reconfiguration is carried out. In this way, the interconnect lines are tested by repeating the partial reconfiguration. Therefore, configuration data to be loaded can be lessened. As a result, an amount of configuration time required to implement the test can be reduced, which leads to the reduction of the testing time.
Patent Document 1: U.S. Pat. No. 7,124,338

### DISCLOSURE OF THE INVENTION

### Problem to be Solved by the Invention

In the test method recited in the Patent Document 1, however, the testing time reduction by the partial reconfiguration is implemented for the interconnect lines (wiring) alone, and calculation elements (logic elements) are still tested by the reconfiguration of the whole PLD. Therefore, the reconfiguration needs to be repeated for each function of the calculation element, and the time for testing the calculation element can not be reduced. Thus, there is still room for improvement in view of an overall testing time of the PLD.

As another problem of the test method recited in the Patent Document 1, it is necessary to additionally provide, in order to materialize partial reconfiguration, circuits for supplying configuration data which is different from data used for the reconfiguration of the whole PLD, and memories for retaining data of partial reconfiguration, resulting in an increased chip area.

The present invention was made to solve the above-mentioned problems, and a main object thereof is to provide a reconfigurable circuit for which a test can be conducted in a shorter testing time as compared with the conventional technology without increasing a chip area, and a method for modifying functions of the reconfigurable circuit.

### Means for Solving the Problem

1) A reconfigurable circuit according to the present invention comprises:

a plurality of calculation elements including a first calculation element and a second calculation element; and

a first configuration memory provided in the first calculation element for storing first configuration data, wherein

output data of the first configuration memory is inputted to the second calculation element.

According to the configurable circuit thus constituted, the first configuration data stored in the first configuration memory can be used for calculation by the second calculation element.

2) According to a mode of the present invention, in the reconfigurable circuit constituted as recited in 1), the output data includes the first configuration data, and the second calculation element updates a predetermined bit of the first configuration data included in the output data.

According to the configurable circuit thus constituted, the predetermined bit of the first configuration data stored in the first configuration memory can be updated by the second calculation element.

3) According to another mode of the present invention, in the reconfigurable circuit constituted as recited in 2), the first configuration data in which the predetermined bit is updated by the second calculation element is inputted to the first configuration memory, so that a predetermined bit of the first configuration data stored in the first configuration memory is changed.

According to the configurable circuit thus constituted, the predetermined bit of the first configuration data stored in the first configuration memory is updated by the second calculation element, and the output of the second calculation element is inputted to the first configuration memory, so that the predetermined bit of the first configuration data stored in the first configuration memory is changed. As a result, a function of the first calculation element can be modified.

Accordingly, it is unnecessary to repeatedly implement reconfiguration for each of the functions of the calculation elements when the calculation elements are tested, which leads to the reduction of a testing time. Another advantage is that the reconfigurable circuit dispenses with a memory and circuit for supplying configuration data to be used for partial reconfiguration, thereby preventing a chip area from increasing.

4) According to still another mode of the present invention, the reconfigurable circuit constituted as recited in 2) further comprises:

a third calculation element; and

a second configuration memory provided in the third calculation element for storing second configuration data, wherein

the first configuration data in which the predetermined bit is updated by the second calculation element is inputted to the second configuration memory, so that a predetermined bit of the second configuration data stored in the second configuration memory is changed.

According to the reconfigurable circuit thus constituted, the predetermined bit of the first configuration data stored in the first configuration memory is updated by the second calculation element, and the output of the second calculation element is inputted to the second configuration memory, so that the predetermined bit of the second configuration data stored in the second configuration memory is changed by the output of the second calculation element. As a result, a function of the third calculation element can be modified. Accordingly, it is unnecessary, as described earlier, to repeatedly implement reconfiguration for each of the functions of the calculation elements when the calculation elements are tested, which leads to the reduction of a testing time. Another advantage is that the reconfigurable circuit dispenses with a memory and circuit for supplying configuration data to be used for partial reconfiguration, thereby preventing a chip area from increasing.

According to still another mode of the present invention, the reconfigurable circuit constituted as recited in 4) further comprises a fourth calculation element, wherein

the fourth calculation element updates a predetermined bit of the second configuration data stored in the second configuration memory and then inputs the updated second configuration data to the first configuration memory.

According to the configurable circuit thus constituted, the predetermined bit of the second configuration data stored in the second configuration memory is updated by the fourth calculation element, and the update result is inputted to the first configuration memory, so that a function of the first calculation element can be modified. Accordingly, it is unnecessary, as described earlier, to repeatedly implement reconfiguration for each of the functions of the calculation elements when the calculation elements are tested and to provide any additional memory and circuit for supplying configuration data to be used for partial reconfiguration, thereby reducing a testing time and preventing a chip area from increasing.

6) A method for modifying functions of a reconfigurable circuit according to the present invention is a method for modifying functions of a reconfigurable circuit comprising a plurality of calculation elements including a first calculation element provided with a first configuration memory for storing configuration data and a second calculation element, including steps of:

configuring the reconfigurable circuit;

executing an application operation in the reconfigurable circuit;

updating a predetermined bit of the configuration data stored in the first configuration memory using the second calculation element; and

changing a predetermined bit of the configuration data stored in the first configuration memory by inputting an update result obtained by the second calculation element to the first configuration memory.

According to the method thus constituted, the predetermined bit of the configuration data stored in the first configuration memory is changed by the second calculation element, without the configuration being implemented again, after the application is executed in the reconfigurable circuit, so that a function of the first calculation element can be modified. The method thus constituted can reduce a testing time for each of the calculation elements, while concurrently controlling any increase of a chip area.

7) A method for modifying functions of a reconfigurable circuit according to the present invention is a method for modifying functions of a reconfigurable circuit comprising a plurality of calculation elements including a first calculation element provided with a first configuration memory for storing first configuration data, a second calculation element, and a third calculation element provided with a second configuration memory for storing second configuration data, including steps of:

configuring the reconfigurable circuit;

executing an application operation in the reconfigurable circuit;

updating a predetermined bit of the first configuration data stored in the first configuration memory using the second calculation element; and

changing a predetermined bit of the second configuration data stored in the second configuration memory by inputting an update result obtained by the second calculation element to the second configuration memory.

According to the method thus constituted, wherein the predetermined bit of the second configuration data stored in the second configuration memory is changed by the second calculation element, without the configuration being implemented again, after the application is executed in the reconfigurable circuit, so that a function of the third calculation element can be modified. The method thus constituted can reduce a testing time for each of the calculation elements, while concurrently controlling any increase of a chip area, as is the case described earlier.

8) A method for modifying functions of a reconfigurable circuit according to the present invention is a method for modifying functions of a reconfigurable circuit comprising a plurality of calculation elements including a first calculation element provided with a first configuration memory for storing first configuration data, a second calculation element, a third calculation element provided with a second configuration memory for storing second configuration data, and a fourth calculation element, including steps of:

configuring the reconfigurable circuit;

executing an application operation in the reconfigurable circuit;

updating a predetermined bit of the first configuration data stored in the first configuration memory using the second calculation element;

updating a predetermined bit of the second configuration data stored in the second configuration memory using the fourth calculation element;

changing a predetermined bit of the second configuration data stored in the second configuration memory by inputting an update result obtained by the second calculation element to the second configuration memory; and

changing a predetermined bit of the first configuration data stored in the first configuration memory by inputting an update result obtained by the fourth calculation element to the first configuration memory.

According to the method thus constituted, the predetermined bit of the second configuration data stored in the second configuration memory is changed by the second calculation element, without configuration being implemented again, after the application is executed in the configurable circuit, so that a function of the third calculation element can be modified. Further, a function of the first calculation element can be modified by changing the predetermined bit of the first configuration data stored in the first configuration memory using the fourth calculation element. The method thus constituted can reduce a testing time for each of the calculation elements, while concurrently controlling any increase of a chip area, as is the case described earlier.

9) A communication device according to the present invention is a communication device for transmitting and receiving an electric wave on which a digital signal encrypted in such a way that modes are shifted in a time-sharing manner is superposed, comprising:

an antenna unit for transmitting or receiving the electric wave;

a front-end processor for synchronizing with an electric wave having a predetermined frequency received by the antenna unit and outputting the electric wave having a predetermined frequency;

a demodulator for outputting a first digital signal from the electric wave having a predetermined frequency;

a digital baseband processor for generating a first application digital signal after providing receiving-end digital baseband processing to the first digital signal outputted from the demodulator;

a decrypting unit for outputting a compressed first digital data after decrypting the first application digital signal outputted from the digital baseband processor;

a decoder for decompressing the compressed first digital data outputted from the decrypting unit;

a D/A converter for converting the decompressed first digital data outputted from the decoder into a first analog signal;

an A/D converter for receiving a second analog signal and converting the second analog signal into a second digital data;

an encoder for compressing the second digital data outputted from the A/D converter;

an encrypting unit for generating a second application digital signal after encrypting the compressed second digital data outputted from the encoder in such a way modes are shifted in a time-sharing manner;

a modulator for generating a second digital signal by providing transmitting-end digital baseband processing to the second application digital signal outputted from the encrypting unit using the digital baseband processor, the modulator further generating a carrier wave signal by superposing the generated second digital signal on carrier wave for transmission; and

a high frequency amplifier for amplifying the carrier wave signal generated by the modulator, wherein

the decrypting unit is constituted by the reconfigurable circuit recited in Claim 2, so that the circuit architecture thereof shifts in a time-sharing manner, and

the encrypting unit is constituted by the reconfigurable circuit recited in Claim 2, so that the circuit architecture thereof shifts in a time-sharing manner.

In the communication device thus constituted, since the encrypting circuit and the decrypting circuit are changed after the elapse of a predetermined time, an extremely high level of concealment can be achieved.

### EFFECT OF THE INVENTION

According to the present invention, a function of a calculation element can be changed using another calculation element, without configuration being implemented, after an application is executed in a reconfigurable circuit. Moreover, it becomes unnecessary to provide a memory and circuit for supplying configuration data to be used for partial reconfiguration, which are required in the conventional technology. Therefore, according to the present invention, a reconfigurable circuit can be tested in a shorter testing time than in the conventional technology without any increase in a chip area.

When the reconfigurable circuit according to the present invention is used as an encrypting circuit and a decrypting circuit to be provided in a communication device, the encrypting circuit and the decrypting circuit can be changed after the elapse of a predetermined time. As a result, a communication device having an extremely high level of concealment can be realized.

### BRIEF DESCRIPTION OF THE DRAWINGS

FIG. 1 is a configuration diagram of a reconfigurable circuit according to preferred embodiment 1-3 of the present invention.

FIG. 2 is a configuration diagram of a calculation element to be provided in the reconfigurable circuit of FIG. 1.

FIG. 3 is a configuration diagram of configuration data of a configuration memory to be provided in the calculation element illustrated in FIG. 2.

FIG. 4 is a configuration diagram of a reconfigurable circuit which has been subjected to configuration in such a way that a function modification method of the reconfigurable circuit according to the preferred embodiment 1 is applicable.

FIG. 5 is a flow chart illustrating processing steps of the function modification method of the reconfigurable circuit according to the preferred embodiment 1.

FIG. 6 is a configuration diagram of a reconfigurable circuit which has been subjected to configuration in such a way that a function modification method of a reconfigurable circuit according to a preferred embodiment 2 of the present invention is applicable.

FIG. 7 is a flow chart illustrating processing steps of the function modification method of the reconfigurable circuit according to the preferred embodiment 2.

FIG. 8 is a configuration diagram of a reconfigurable circuit which bas been subjected to configuration in such a way that a function modification method of a reconfigurable circuit according to a preferred embodiment 3 of the present invention is applicable.

FIG. 9 is a flowchart (1) illustrating processing steps of the function modification method of the reconfigurable circuit according to the preferred embodiment 3.

FIG. 10 is a flow chart (2) illustrating processing steps of the function modification method of the reconfigurable circuit according to the preferred embodiment 3.

FIG. 11 is a flow chart illustrating the details of an operation in Step n28 of the flow chart of FIG. 9.

FIG. 12 is a timing chart of the number of cycles in a test circuit operation in the calculation element illustrated in FIG. 8.

FIG. 13 is a timing chart of the number of cycles in a conventional test method.

FIG. 14 is a conceptual diagram a communication device incorporating the reconfigurable circuit according to the present invention.

FIG. 15 is a block diagram illustrating the overall signal processing of the communication device incorporating the reconfigurable circuit according to the present invention.

FIG. 16A is a configuration diagram illustrating an operation of a system LSI 1401.

FIG. 16B is a configuration diagram illustrating the operation of the system LSI 1401.

### DESCRIPTION OF REFERENCE SYMBOLS

A reconfigurable circuit
1 calculation element
2 wiring
3 data memory
4 test ROM
5 clock generating block
6 external IO block
7 operation sequence control circuit
11 configuration memory
12 input register
13 calculation block
14 output register
15 switch box
16 configuration chain
17 configuration sector
18 configuration data input switch box
19 configuration data output switch box
20 output selector
21 write data
22 sequence control
C1 configuration
C2 shift to application-execute mode
C3 capture of calculation result
C4 memory write
C5 change of configuration memory
C6 shift to read-back mode
C7 read of data memory
C8 shift to configuration mode
C9 shift out of output register data
D1 configuration data for switch box
D2 configuration data for input register
D3 configuration data for output register
D4 configuration data for configuration input switch box
D5 configuration data for configuration output switch box
D6 configuration data for calculation block
E1-E8 first-eighth calculation elements
S1 configuration mode signal
S2 application mode signal
S3 configuration selector control signal
S4 configuration memory-write enable signal
S5 address
S6 write enable
S7 output selector control signal
S8 test termination signal
S9 calculation data selector control signal
1401 system LSI
1402 substrate
1403 mobile telephone
1501 antenna
1502 antenna switching circuit
1503 front-end IC
1504 intermediate frequency amplifying circuit
1505 demodulating circuit
1506 system LSI
1507 speaker
1508 microphone
1509 flash memory
1510 modulating circuit
1511 high frequency amplifying circuit

### PREFERRED EMBODIMENTS OF THE PRESENT INVENTION

Hereinafter, preferred embodiments of a reconfigurable circuit and a method for modifying functions of the reconfigurable circuit according to the present invention are described in detail referring to the drawings.

### Preferred Embodiment 1

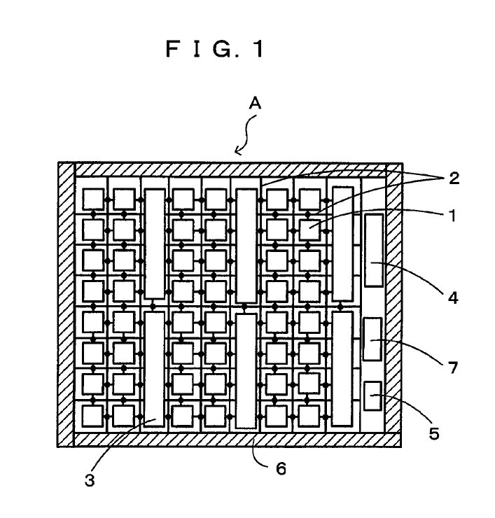

FIG. 1 is a configuration diagram of a reconfigurable circuit according to a preferred embodiment 1 of the present invention. A reconfigurable circuit A comprises a plurality of calculation elements disposed in juxtaposition in horizontal and vertical directions, wiring 2 provided between the calculation elements 1 in the horizontal and vertical directions to connect the calculation elements 1, data memories 3 methodically disposed, a test ROM 4 for supplying configuration data to be used in a test to the reconfigurable circuit A, a clock generating block 5 for supplying clock signals to the calculation elements 1 and the data memories 3, an external IO block 6 for communicating with the outside of a chip, and an operation sequence control circuit 7 for controlling a sequence configuration operation or application circuit operation of the reconfigurable circuit A.

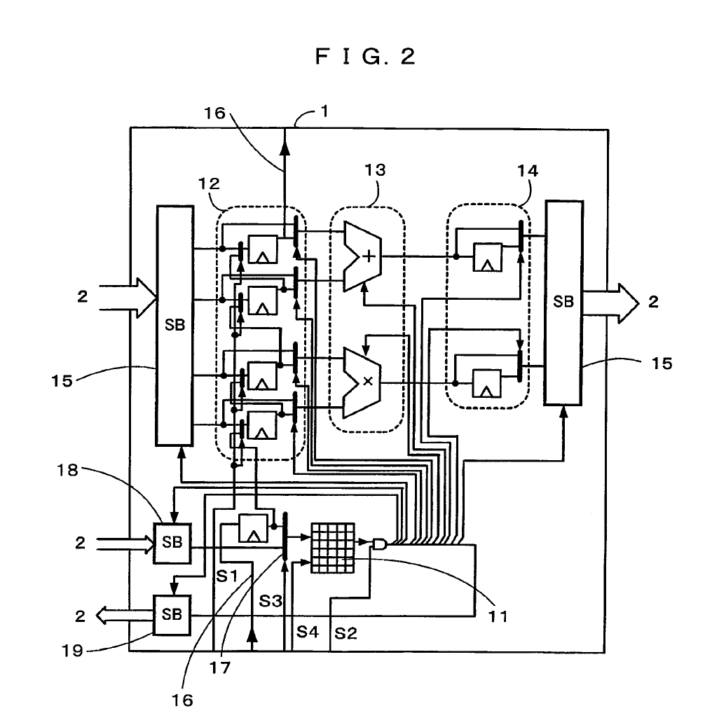

FIG. 2 is a configuration diagram specifically illustrating a detailed constitution of the calculation element 1 to be loaded in the reconfigurable circuit A of FIG. 1. The calculation element 1 comprises a configuration memory 11, an input register 12, a calculation block 13, an output register 14, a switch box 15, a configuration chain 16, a configuration selector 17, a configuration data input switch box 18, and a configuration data output switch box 19.

In the configuration memory 11, information of circuit architectures is stored. The input register 12 can temporarily retain data to be inputted to the calculation block 13 based on a program stored in the configuration memory 11. An arithmetic and logic circuit, a multiplier, and others constitute the calculation block 13. The calculation block 13 can carry out several types of calculations based on a program stored in the configuration memory 11. The output register 14 can temporarily retain an output from the calculation block 13 based on a program stored in the configuration memory 11. The switch box 15 can connect an input terminal of the input register 12 and an output terminal of the output register 14 to the wiring 2 which connects the calculation elements 1 based on a program stored in the configuration memory 11. The configuration chain 16 transfers configuration data to be stored in the configuration memory 11 at the time when the reconfigurable circuit A is subjected to configuration and an initial value to be set in the input register 12 to the configuration memory 11 and the input register 12. The transfer is carried out in a shift-register manner. The configuration selector 17 selects either data from the configuration chain 16 or data from the outside of the calculation elements 1 as the configuration data to be written in the configuration memory 11. The configuration data input switch box 18 can connect an input terminal of the configuration memory 11 to the wiring 2 (which connects the calculation elements 1). This connection is controlled based on a program stored in the configuration memory 11. The configuration data output switch box 19 can connect an output terminal of the configuration memory 11 to the wiring 2 (which connects the calculation elements 1). This connection is controlled based on a program stored in the configuration memory 11.

The calculation element 1 comprises, in its signal system, a configuration mode signal S1 formed on the configuration chain 16 by the input register 12 and the output register 14, an application mode signal S2 for setting the calculation element 1 in an application-execute mode, a configuration selector control signal S3 for controlling the configuration selector 17, and a configuration memory-write enable signal S4 for writing data in the configuration memory 11.

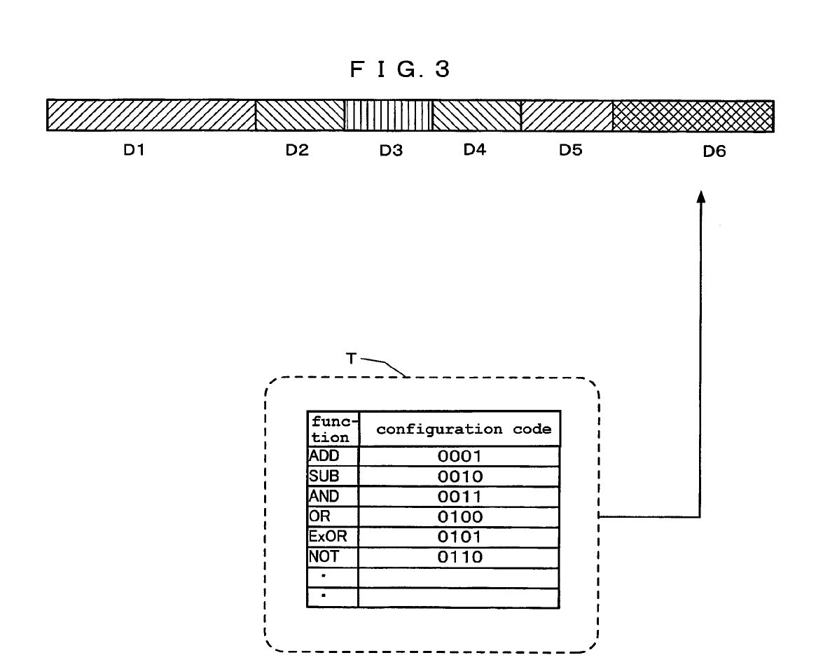

FIG. 3 is an illustration of the configuration data to be stored in the configuration memory 11. The configuration data comprises configuration data D1 for switch box to be used for deciding a connection state of the switch box 15, configuration data D2 for input register to be used for deciding a connection state of the input register 12, configuration data D3 for output register to be used for deciding a connection state of the output register 14, configuration data D4 for configuration data input switch box to be used for deciding a connection state of the configuration data input switch box 18, configuration data D5 for configuration data output switch box to be used for deciding a connection state of the configuration data output switch box 19, and configuration data D6 for calculation block to be used for deciding a calculation by the calculation element 13. Table T shows a correspondence relation between configuration codes for deciding functions of the arithmetic and logic calculation circuit of the calculation block 13 and functions of the arithmetic and logic calculation circuit in the configuration data D6 for calculation block.

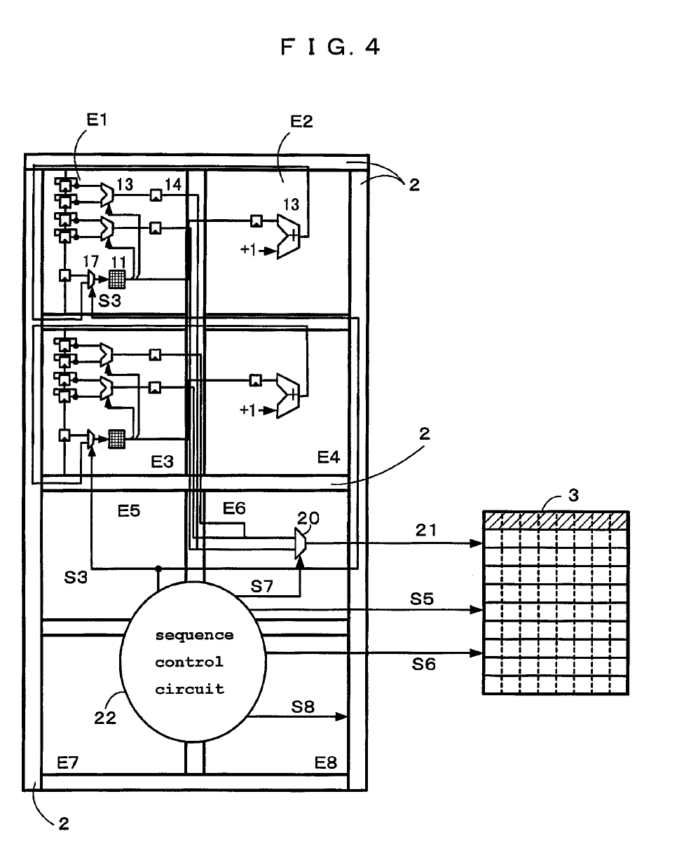

FIG. 4 is an illustration of a circuit architecture (1) of the reconfigurable circuit A at the time when the reconfigurable circuit is subjected to configuration as described below. The “configuration” used here means, in the case of the reconfigurable circuit A which has a constitution shown in FIGS. 1 and 2 and whose configuration data in the calculation element 1 has a constitution shown in FIG. 3, configuration which makes the below-mentioned test feasible in the arithmetic and logic calculation circuit of the calculation block 13. The “test” used here means that a plurality of calculation elements 1 and a data memory 3 are paired, a test circuit of the arithmetic and logic calculation circuit of the calculation block 13 in the reconfigurable circuit A is thereby constituted, and an arithmetic and logic calculation circuit of a first calculation element E1 is tested by the test circuit. As illustrated in FIG. 4, another calculation element may be concurrently tested.

An output terminal of the configuration memory 11 (E1) in the first calculation element E1 is connected to an input terminal of an arithmetic and logic calculation circuit of a calculation block 13 (E2) in a second calculation element E2 adjacent thereto. An output terminal of the arithmetic and logic circuit of the calculation block 13 (E2) in the second calculation element E2 is connected to a configuration selector 17 (E1) of the first calculation element E1 by way of a configuration data input switch box 18 (E1) (not shown) of the first calculation element E1. An output terminal of an output register 14 in the first calculation element E1 is connected to a write-data input terminal 21 of the data memory 3 by way of an output selector 20 (constituted by fifth-eighth calculation elements E5-E8) and the wiring 2.

A sequence control circuit 22 (constituted by fifth-eighth calculation elements E5-E8) outputs an address signal S5 and a write enable signal S6 for controlling the data memory 3. The address signal S5 and the write enable signal S6 are supplied to an address terminal and a write enable terminal of the data memory 3 by way of the wiring 2. The sequence control circuit 22 outputs a configuration selector control signal S3 (E1) of the first calculation element E1. The configuration selector control signal S3 (E1) is supplied to the configuration selector 17 (E1) of the first calculation element E1 by way of the wiring 2. The sequence control circuit 22 outputs an output selector control signal S7. The output selector control signal S7 is supplied to the output selector 20 by way of the wiring 2. The sequence control circuit 22 outputs a test termination signal S8. The test termination signal S8 is connected to the operation sequence control circuit 7 (see FIG. 1) by way of the wiring 2.

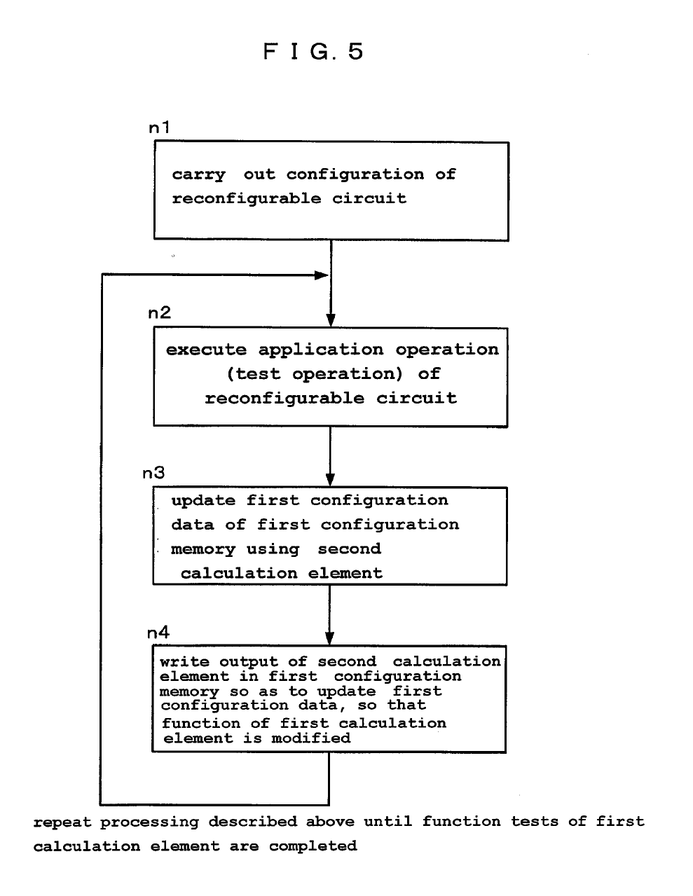

Referring to a flow chart illustrated in FIG. 5 is described an operation of the test circuit for the arithmetic and logic circuits in the calculation blocks 13 of the reconfigurable circuit A of FIG. 4. First, the reconfigurable circuit A is subjected to configuration with respect to the test circuit of the arithmetic and logic circuit in the first calculation element E1 illustrated in FIG. 4 (Step n1).

Next, an application operation is carried out in the reconfigurable circuit; namely, the calculation of the arithmetic and logic circuit of the first calculation element E1 is carried out, then, a calculation result thereby obtained is retained in a register, and the calculation result retained in the register is stored in the data memory 3 (Step n2).

After the test, a predetermined bit of the configuration data stored in the configuration memory 11 (E1) of the first calculation element E1 is updated by the second calculation element E2 (Step n3).

Next, an output of the second calculation element E2 is written in the configuration memory 11 (E1) of the first calculation element E1, and a predetermined bit of the configuration data stored in the configuration memory 11 (E1) of the first calculation element E1 is updated, so that a function of the first calculation element E1 is modified (Step n4).

The operations of the Steps n2, n3 and n4 are repeatedly carried out until the test for all of the functions of the first calculation element E1 is completed. Then, the tests of the first calculation element E1 are completed.

As described so far, according to the present preferred embodiment, once the configuration is implemented one time at the beginning of the test for the arithmetic and logic circuit of the first calculation element E1, the data of the configuration memory 11 (E1) of the arithmetic and logic circuit in the first calculation element E1 is thereafter changed by the second calculation element E2. Thus, one time configuration at the beginning of the test is enough to test all of the functions of the arithmetic and logic circuit in the first calculation element E1. Therefore, the functions can be tested in a shorter period of time as compared with the conventional test method wherein the configuration is repeated for each of the functions of the arithmetic and logic circuit.

### Preferred Embodiment 2

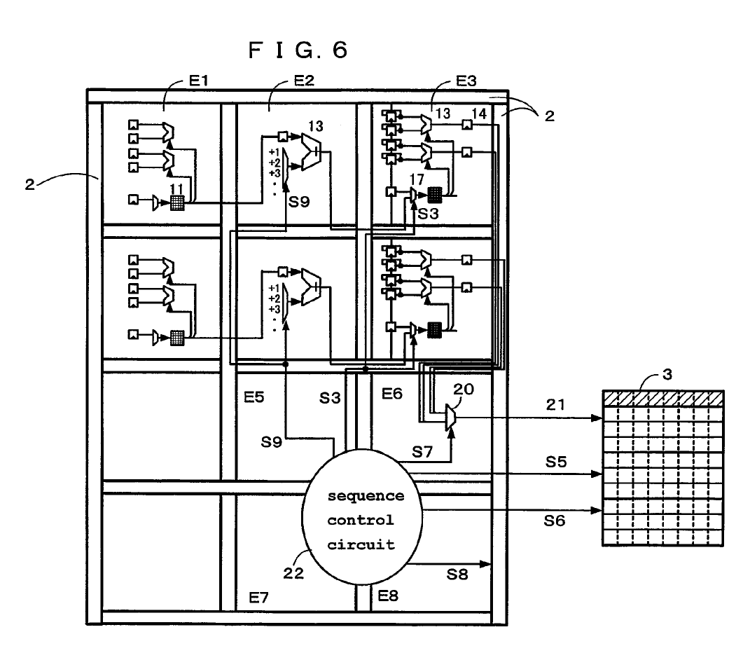

A preferred embodiment 2 of the present invention has a circuit architecture (2) where the reconfigurable circuit A is subjected to configuration as described below, as illustrated in FIG. 6. The “configuration” used here means, in the case of the reconfigurable circuit A which has a constitution shown in FIGS. 1 and 2 and whose configuration data in the calculation element has a constitution shown in FIG. 3, configuration which makes the below-mentioned test feasible in the arithmetic and logic calculation circuit of the calculation block 13. The “test” used here means that a plurality of calculation elements 1 and a data memory 3 are paired, a test circuit of the arithmetic and logic circuit of the calculation block 13 in the reconfigurable circuit A is thereby constituted, and an arithmetic and logic calculation circuit of a third calculation element E3 is tested by the test circuit. As illustrated in FIG. 6, another calculation element may be concurrently tested.

The output terminal of the configuration memory 11 (E1) in the first calculation element E1 is connected to the input terminal of the arithmetic and logic circuit of the calculation block 13 (E2) in the second calculation element E2 adjacent thereto. The output terminal of the arithmetic and logic circuit of the calculation block 13 (E2) in the second calculation element E2 is connected to a configuration selector 17 (E3) of the third calculation element E3 by way of a configuration data input switch box 18 (E3) (not shown) of the third calculation element E3. An output terminal of an output register 14 (E3) in the third calculation element E3 is connected to a write data input terminal 21 of the data memory 3 by way of the output selector 20 (constituted by fifth-eight calculation elements E5-E8) and wiring 2.

The sequence control circuit 22 (constituted by fifth-eight calculation elements E5-E8) outputs the address signal S5 and the write enable signal S6 for controlling the data memory 3. The address signal S5 and the write enable signal S6 are supplied to the address terminal and the write enable terminal of the data memory 3 by way of the wiring 2. The sequence control circuit 22 outputs the configuration selector control signal S3 (E3) of the third calculation element E3. The configuration selector control signal S3 (E3) is supplied to the configuration selector 17 (E3) of the third calculation element E3 by way of the wiring 2. The sequence control circuit 22 outputs the output selector control signal S7. The output selector controls signal S7 is supplied to the output selector 20 by way of the wiring 2. The sequence control circuit 22 outputs the test termination signal S8. The test termination signal S8 is supplied to the operation sequence control circuit 7 (see FIG. 1) by way of the wiring 2. The sequence control circuit 22 outputs a calculation data selector control signal S9. The calculation data selector control signal S9 is a control signal for selecting a value to be calculated by the configuration data of the first calculation element E1 in the arithmetic and logic circuit of the calculation block 13 (E2) in the second calculation element E2. The calculation data selector control signal S9 is supplied to the second calculation element E2 by way of the wiring 2.

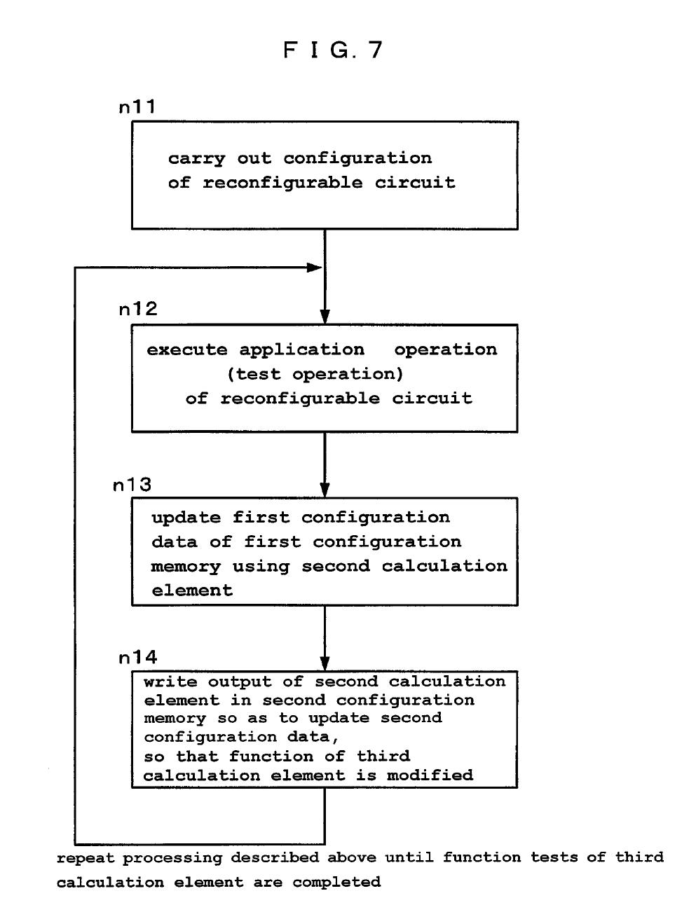

Referring to the flow chart of FIG. 7 is described an operation of the test circuit for the arithmetic and logic circuits in the calculation blocks 13 of the reconfigurable circuit A illustrated in FIG. 6. First, the reconfigurable circuit A is subjected to configuration with respect to the test circuit of the arithmetic and logic circuit of the third calculation element E3 illustrated in FIG. 4 (Step n11).

Next, the test operation of the arithmetic and logic circuit is carried out in the following way: Application operation (calculation in the arithmetic and logic circuit of the third calculation element E3) is carried out in the reconfigurable circuit A, a calculation result thereby obtained is retained in a register, and the calculation result retained in the register is stored in the data memory 3 (Step n12).

After the test, a predetermined bit of the configuration data stored in the configuration memory 11 (E1) of the first calculation element E1 is updated by the second calculation element E2 (Step n13).

Next, the output of the second calculation element E2 is written in the configuration memory 11 (E3) of the third calculation element E3, and a predetermined bit of the configuration data stored in the configuration memory 11 (E3) of the third calculation element E3 is updated, so that a function of the third calculation element E3 is modified (Step n14).

The operations of the Steps n12, n13 and n14 are repeatedly carried out until the test of all of the functions of the third calculation element E3 is completed. Then, the test of the third calculation element E3 is terminated. The value by which the configuration data stored in the configuration memory 11 (E1) of the first calculation element E1 is calculated in the second calculation element E2 is changed in accordance with the number of repetition based on the calculation data selector control signal S9 outputted from the sequence control circuit 22.

As described so far, according to the present preferred embodiment, once the configuration is implemented one time at the beginning of the test for the arithmetic and logic circuit of the third calculation element E3, the data of the configuration memory 11 (E3) of the arithmetic and logic circuit in the third calculation element E3 is thereafter changed by the second calculation element E2. Thus, one time configuration at the beginning of the test is enough to test all of the functions of the arithmetic and logic circuit in the third calculation element E3. Therefore, the functions can be tested in a shorter period of time as compared with the conventional test method wherein the configuration is repeated for each of the functions of the arithmetic and logic circuit.

### Preferred Embodiment 3

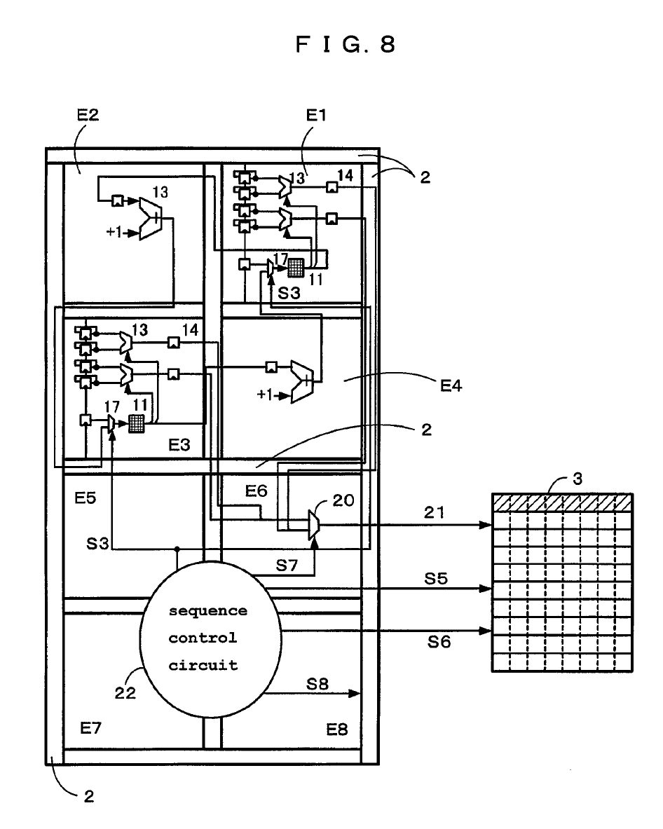

A preferred embodiment 3 of the present invention has a circuit architecture (3) where the reconfigurable circuit A is subjected to configuration as described below, as illustrated in FIG. 8. The “configuration” used here means, in the case of the reconfigurable circuit which has a constitution shown in FIGS. 1 and 2 and whose configuration data in the calculation element has a constitution shown in FIG. 3, configuration which makes the below-mentioned test feasible in the arithmetic and logic calculation circuit of the calculation block 13. The “test” used here means that eight calculation elements 1 and a data memory 3 are paired, a test circuit of the arithmetic and logic calculation circuit of the calculation block 13 in the reconfigurable circuit A is thereby constituted, and the arithmetic and logic circuit of the calculation block 13 (E1) in the first calculation element E1 (one of the eight calculation elements) and the arithmetic and logic circuit of the calculation block 13 (E3) in the third calculation element E3 (one of the eight calculation elements) diagonally disposed with respect to the first calculation element E1 are tested.

The output terminal of the configuration memory 11 (E1) in the first calculation element E1 is connected to the input terminal of the arithmetic and logic circuit of the calculation block 13 (E2) in the second calculation element E2 adjacent thereto. The output terminal of the arithmetic and logic circuit of the calculation block 13 (E2) in the second calculation element E2 is connected to the configuration selector 17 (E3) of the third calculation element E3 by way of the configuration data input switch box 18 (E3) (not shown) of the third calculation element E3. The output terminal of the configuration memory 11 (E3) in the third calculation element E3 is connected to an input terminal of an arithmetic and logic circuit of a calculation block 13 (E4) in a fourth calculation element E4 adjacent thereto. An output terminal of the arithmetic and logic circuit of the calculation block 13 (E4) in the fourth calculation element E4 is connected to the configuration selector 17 (E1) of the first calculation element E1 by way of the configuration data input switch box 18 (E1) (not shown) of the first calculation element E1. The output terminal of the output register 14 (E1) of the first calculation element E1 and the output terminal of the output register 14 (E3) of the third calculation element E3 are connected to the write data input terminal 21 of the data memory 3 by way of the output selector 20 (constituted by fifth-eight calculation elements E5-E8) and wiring 2.

The sequence control circuit 22 outputs the address signal S5 and the write enable signal S6 for controlling the data memory 3. The address signal S5 and the write enable signal S6 are supplied to the address terminal and the write enable terminal of the data memory 3 by way of the wiring 2 The sequence control circuit 22 outputs the configuration selector control signals S3 (E1) and S3 (E3) of the first and third calculation elements E1 and E3. The configuration selector control signals S3 (E1) and S3 (E3) are supplied to the configuration selector 17 (E1) of the first calculation element E1 and the configuration selector 17 (E3) of the third calculation element E3 by way of the wiring 2. The sequence control circuit 22 outputs the output selector control signal S7. The output selector control signal S7 is supplied to the output selector 20 by way of the wiring 2. The sequence control circuit 22 outputs the test termination signal S8. The test termination signal S8 is supplied to the operation sequence control circuit 7 (see FIG. 1) by way of the wiring 2.

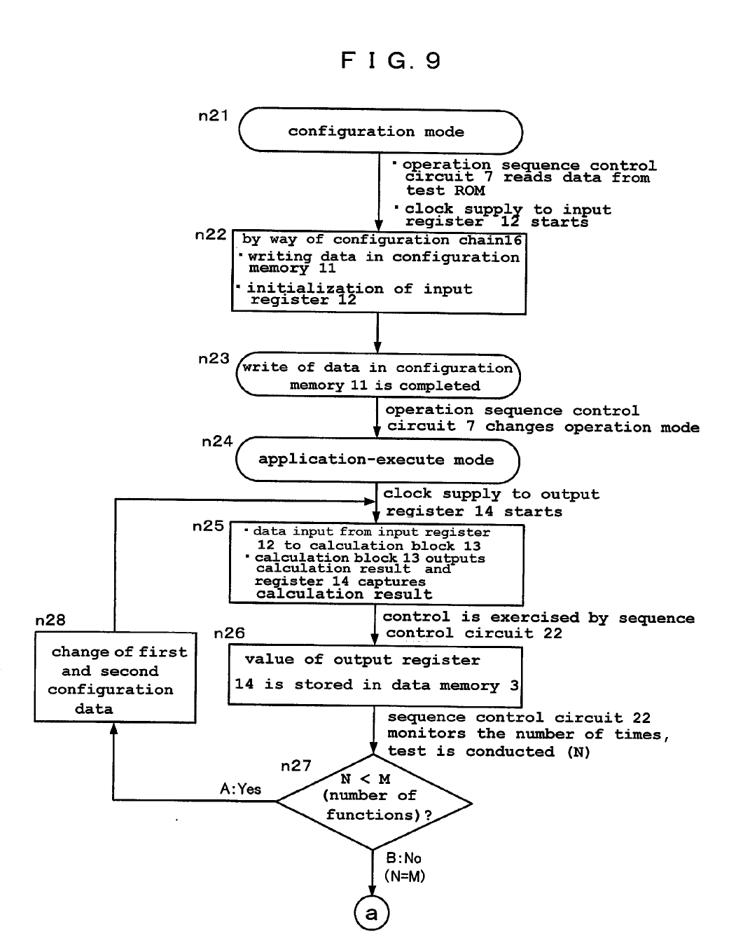

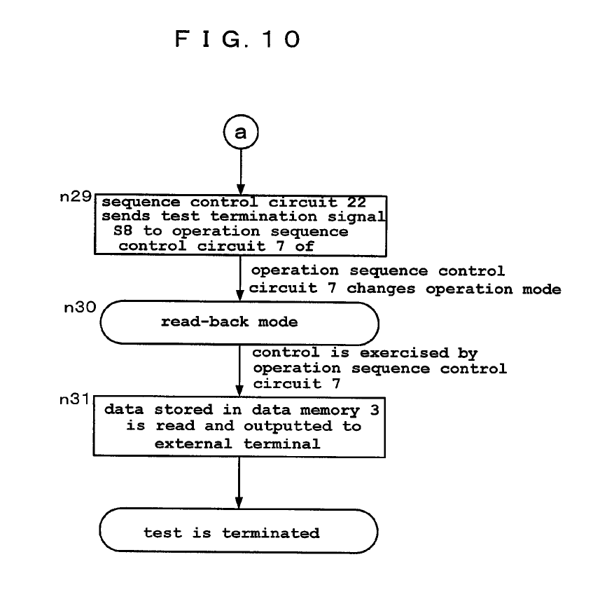

An operation of the test circuit for the arithmetic and logic circuits in the calculation blocks 13 of the reconfigurable circuit A illustrated in FIG. 8 is described below referring to flow chart of FIGS. 9 and 10. The reconfigurable circuit A enters a configuration mode as its initial state (Step n21). By doing so, the configuration is commenced by the operation sequence control circuit 7 of the reconfigurable circuit A. The operation sequence control circuit 7 reads the configuration data from the test ROM 4 and supplies the read data to the reconfigurable circuit A, and the supply of clocks to the input register concurrently starts. Then, the configuration chain 16 starts to operate as a shift register. As a result, the configuration data is supplied to the configuration memories 11 (E1) and 11 (E3) by way of the configuration chain 16.

In the input register 12, an initial value is set through the configuration chain 16 (Step n22). The configuration data to be supplied from the test ROM 4 serves as configuration codes for providing the circuit architecture illustrated in FIG. 8.

When the operation described so far is repeated and the supply of the configuration data from the test ROM 4 is completed, the process in which the configuration data is written in the configuration memories 11 (E1) and 11 (E3) is completed (Step n23).

After a mode change thereafter implemented by the operation sequence control circuit 7 of the reconfigurable circuit A (see FIG. 1), the operation mode shifts from the configuration mode to an application-execute mode (Step n24). In the application-execute mode, the supply of clocks starts for the output register 14 (E1) of the first calculation element E1 and the output register 14 (E3) of the third calculation element E3. The input data retained in the input register 12 (E1) of the first calculation element E1 and the input data retained in the input register 12 (E3) of the third calculation element E3 are inputted to the arithmetic and logic circuit of the calculation block 13 (E1) in the first calculation element E1 and the arithmetic and the logic circuit of the calculation block 13 (E3) in the third calculation element E3, respectively, and then calculated therein. Calculation results obtained by the arithmetic and logic circuits are retained (captured) in the output register 14 (E1) of the first calculation element E1 and the output register 14 (E3) of the third calculation element E3, respectively, at the rising edge of a clock which comes immediately after the completion of the shift to the application-execute mode (Step n25).

Next, the value retained in the output register 14 (E1) of the first calculation element E1 and the value retained in the output register 14 (E3) of the third calculation element E3 are stored in the data memory 3 based on the control of the sequence control circuit 22 (Step n26). At the time, the sequence control circuit 22 controls the write of the values so that the value of the output register 14 (E1) of the first calculation element E1 is written at addresses, {(N−1)×4} and {(N−1)×4+1} of the data memory 3 and thereafter the value of the output register 14 (E3) of the third calculation element E3 are written at address, {(N−1)×4+2} and {(N−1)×4+3}. N in these addresses denotes the number of times test are conducted (N≧1). The Nth test is completed after these values are written.

The sequence control circuit 22 monitors the number of times the tests are completed (Step n27). In the case where the number of tests N is smaller than the number of functions M of the arithmetic and logic circuits, the sequence control circuit 22 makes a change to the configuration memory 11 (E1) of the first calculation element E1 and the configuration memory 11 (E3) of the third calculation element E3 using the second calculation element E2 and the fourth calculation element E4 (Step n28).

Thereafter, the operations of the Steps n25, n26, n27, and n28 are repeated.

The sequence control circuit 22 monitors the number of times the tests are completed (Step n27). In the case where the number of tests N is equal to the number of functions M of the arithmetic and logic circuits (B in Step n27), the sequence control circuit 22 judges that all of the functions of the arithmetic and logic circuit of the first calculation element E1 and the functions of the arithmetic and logic circuit of the third calculation element E3 have been tested. Then, the sequence control circuit 22 transmits the test termination signal S8 to the operation sequence control circuit 7 (see FIG. 1) of the configurable circuit A by way of the wiring 2 (Step n29). The operation sequence control circuit 7 (see FIG. 1) that received the signal shifts the operation mode of the reconfigurable circuit A to a read-back mode (Step n30). In the read-back mode, the data memory 3 is connected on the configuration chain 16, and the operation sequence control circuit 7 (see FIG. 1) outputs the calculation result of the first calculation element E1 and the calculation result of the third calculation result E3 stored in the data memory 3 to an external terminal of the configurable circuit A by way of the configurable chain 16 (Step n31). This outputting is carried out in a shift-register manner. The outputted results are compared to an expected value by means of the LSI tester and the arithmetic and logic circuits in the first and third calculation elements E1 and E3 are tested.

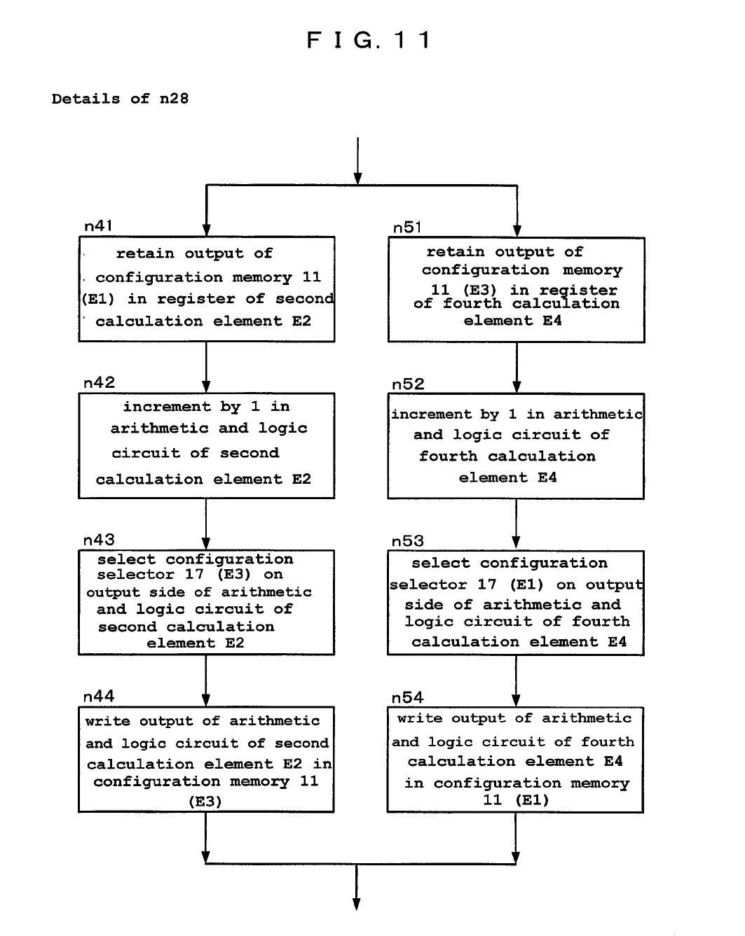

FIG. 11 is a flow chart illustrating the details of the operation which makes a change to the configuration memory 11 (E1) of the first calculation element E1 and the configuration memory 11 (E3) of the third calculation element E3 in Step n28 in the flow chart of FIG. 9. First, the output of the configuration memory 11 (E1) of the first calculation element E1 is retained in the input register 12 (E2) of the second calculation element 2 (Step n41).

Next, the arithmetic and logic circuit in the second calculation element E2 increments the data of the input register 12 (E2) by 1 (Step n42). Next, the output side of the arithmetic and logic circuit in the second calculation element E2 is selected in the configuration selector 17 (E3) in the third calculation element 17 (E3) (Step n43). Finally, the output of the arithmetic and logic circuit in the second calculation element E2 is written in the configuration memory 11 (E3) of the third calculation element E3 (Step n44).

Concurrently with the operations of the Steps n41-n44, the following operation is carried out. First, the output of the configuration memory 11 (E3) in the third calculation element E3 is retained in the input register 12 (E4) of the fourth calculation element E4 (Step n51). Next, the arithmetic and logic circuit of the fourth calculation element E4 increments the data of the input register 12 (E4) by 1 (Step n52). Then, the output side of the arithmetic and logic circuit in the fourth calculation element E4 is selected in the configuration selector 17 (E1) of the first calculation element E1 (Step n53). Finally, the output of the arithmetic and logic circuit in the fourth calculation element E4 is written in the configuration memory 11 (E1) of the first calculation element E1 (Step n54).

In consequence of the operation described so far, the change in the configuration memory 11 (E1) in the first calculation element E1 and the configuration memory 11 (E3) in the third calculation element E3 is completed.

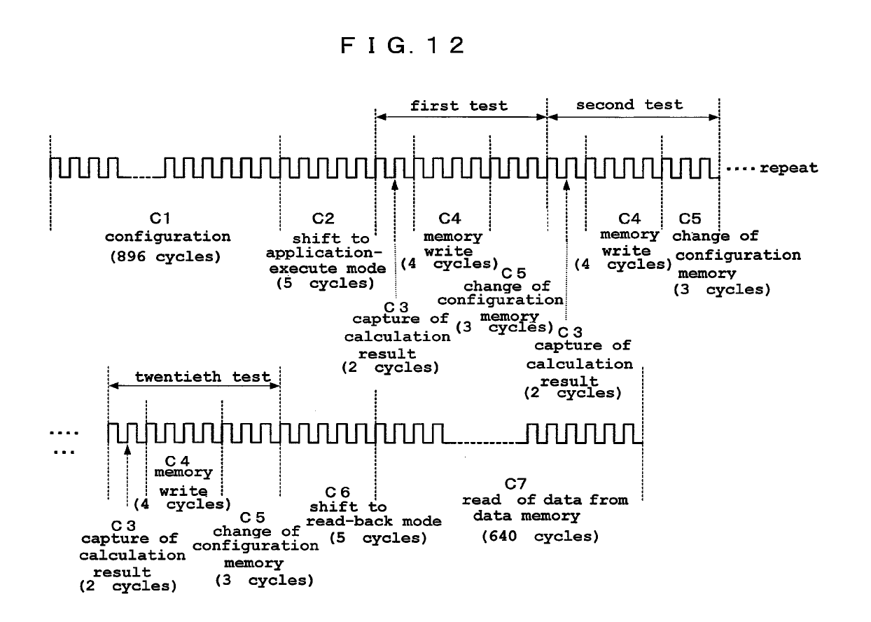

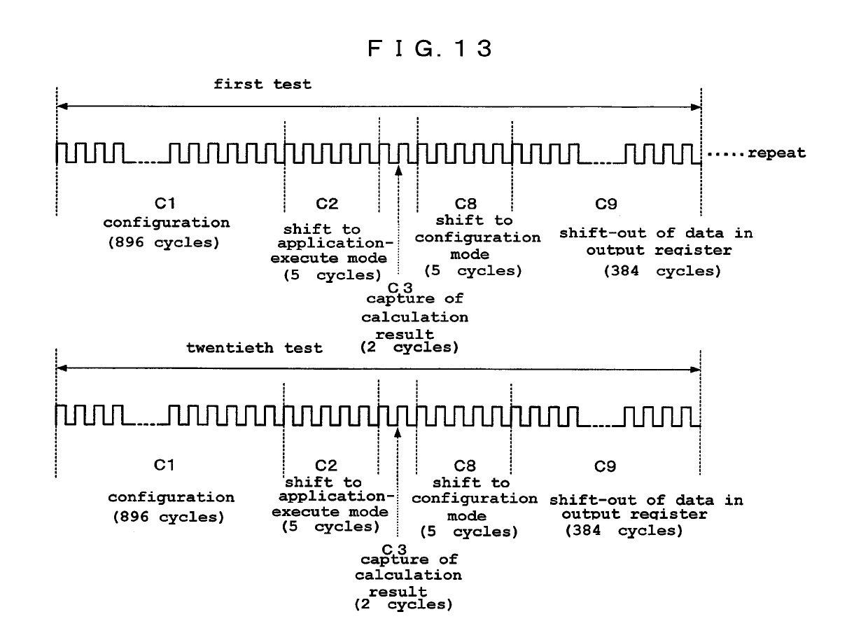

Referring to a timing chart of FIG. 12 is described the number of cycles required for testing the arithmetic and logic circuits of the calculation blocks 13 in the reconfigurable circuit A illustrated in FIG. 8. The description is given below based on an assumed case where 20 different functions of the arithmetic and logic circuits are tested in a reconfigurable circuit A comprising 64 calculation elements in total; eight calculation elements disposed longitudinally and eight calculation elements disposed laterally. For a comparison purpose, the description given below includes the number of cycles required for the test according to the conventional method illustrated in FIG. 13.

According to the conventional method, the configuration (C1) for testis carried out to begin with. In the conventional test method, since it is necessary to read the calculation results retained in the output register 14 as described later, its constitution is such that in FIG. 2, the output register 14 is also disposed on the configuration chain 16. Assuming that the configuration memory 11 has the size of 32 bits, and each of the input register 12 and the output register 14 has the size of 4 bits in its widths, the number of bits initially necessary is 32 bits+4 bits×6=56 bits. Assuming that there is a shift by 4 bits per cycle in the configuration chain 16, the configuration data can be supplied to one calculation element at the rate of 14 cycles (56 bits/4 bits=14 cycles). Therefore, the number of cycles necessary for the configuration (C1) is, with 64 calculation elements in total, 14 cycles×64=896 cycles.

After the configuration (C1) is completed, the reconfigurable circuit A shifts to the application-execute mode (C2). It requires 5 cycles for all of the calculation elements in the reconfigurable circuit A to safely shift to the application-execute mode, because the operation mode control signal is generated by the operation sequence control circuit 7 (see FIG. 1) disposed at an edge of the reconfigurable circuit A and the signal is supplied from there to all of the calculation elements, which causes large delay.

After the shift to the application-execute mode, the input data is supplied from the input register 12 to the arithmetic and logic circuit in the calculation element, predetermined calculation is carried out in the arithmetic and logic circuit and the calculation result is outputted. The calculation result is captured by the output register 14 at the rising edge of the next clock (C3).

In the conventional method, the reconfigurable circuit A shifts to the configuration mode (C8). As is the case with the shift to the application-execute mode (c2), 5 cycles are necessary for the shift.

The data of the output register 14 is then shifted outside by way of the configuration chain 16 (C9). The data to be shifted out is 4 bits×2=8 bits in each calculation element and there exists the input register 12 on the configuration chain 16, resulting in 4 bits×6=24 bits. With a shift of 4 bit per cycle, 24 bits/4 bits=6 cycles are necessary. The total number of the calculation elements is 64. To output the calculation results of all of the calculation elements, therefore, 6 cycles×64=384 cycles are necessary. The five operations C1, C2, C3, C8 and C9 are a sequence of operations required for one test and are repeated 20 times to complete all of the tests in the reconfigurable circuit A. Therefore, the number of cycles necessary for completing the tests is (896+5+2+5+384)×20=25,840 cycles.

In contrast, the method according to the present invention carries out the configuration (C1) for the test, to start with, as illustrated in FIG. 12. As described in the flow chart of FIG. 10, the calculation results are read from the data memory 3, which makes it unnecessary to connect the output register 14 on the configuration chain as illustrated in FIG. 2. Therefore, the bit number necessary for initialization is 32 bits+4 bits×4=48 bits. As a result, the number of cycles necessary for the configuration (C1) is (48 bits/4 bits)×64=768 cycles. Thus, the number of required cycles can be reduced by 128 cycles.

After the configuration (C1) is completed, the reconfigurable circuit A shifts to the application-execute mode (C2), and 5 cycles are necessary in the shift as is the case with the conventional method. After the shift to the application-execute mode, the input data is supplied from the input register 12 to the arithmetic and logic circuit in the calculation element and predetermined calculation is carried out there, and the calculation result is outputted from the arithmetic and logic circuit. Then, the calculation result is captured by the output register 14 at the rising edge of the next clock (C3). After that, the data retained in the output register 14 is written in the data memory 3 by the sequence control circuit 22 (C4). Since there are four output registers: two in the first calculation element E1 and two in the third calculation element E3, 4 cycles are necessary for writing the data in the data memory 3. Next, the configuration data of the configuration memory 11 in the first calculation element E1 and the configuration data of the configuration memory 11 in the third calculation element E3 are changed using the second calculation element E2 and the fourth calculation element E4 (C5). The operations of C3, C4 and C5 are a sequence of operations required for one test and are repeated 20 times.

Then, the reconfigurable circuit A shifts to the read-back mode (C6). This shift requires 5 cycles as is the case with the shift to the application-execute mode (C2). After the shift to the read-back mode, the reconfigurable circuit A reads out to the outside the calculation results stored in the data memory 3 based on the control of the operation sequence control circuit 7 (see FIG. 1) (C7).

All of the data in the four output registers 14 are written in the dat memory 3 in one test, which means that the data of 4 bits×4=16 bits is written in the data memory 3. Since the test is repeated 20 times, the written data has the volume of 16 bits×20=320 bits. Since there are eight data memories 3 in the reconfigurable circuit A, the data volume is 320 bits×8=2,560 bits. When data of 4 bits is read out to the outside at one time, 2,560 bits/4 bits=640 cycles are necessary. As a result, the number of cycles necessary for all of the tests described so far is 768+5+(2+4+3)×20+5+640=1,598 cycles. Further, in order to carry out the test for all of the calculation elements, the test is carried out four times; at each time, a calculation element to be tested is changed. The number of cycles in total for completing the tests is 1,598 cycles×4=6,392 cycles. According to the method provided by the present invention, the number of cycles required for the tests can be reduced to about ¼ of that of the conventional method.

As so far described, according to the present preferred embodiment, one time configuration at the beginning of the test is enough to test the arithmetic and logic circuit of the first calculation element E1 and the arithmetic and the logic circuit of the third calculation element E3. After the one-time configuration, all of the functions of the arithmetic and logic circuit in the first calculation element E1 and the arithmetic and the logic circuit in the third calculation element E3 are tested while the data in the configuration memory 11 (E1) of the arithmetic and the logic circuit in the first calculation element E1 and the data in the configuration memory 11 (E3) of the arithmetic and the logic circuit in the third calculation element E3 are being automatically changed whenever necessary by the second calculation element E2 and the fourth calculation element E4. Therefore, the functions of the arithmetic and logic circuits can be tested in the number of cycles reduced to ¼ as compared with the conventional technology wherein configuration is carried out for each of the functions of the arithmetic and logic circuits.

Though not illustrated in the drawings, all of the possible connections associated with the wiring 2 connected to the first calculation element E1 and the wiring 2 connected to the third calculation element E3 can be tested through one time configuration at the beginning of the test when the configuration data d1 for switch box illustrated in FIG. 3 is changed by the second calculation element E2 and the fourth calculation element E4 using a test circuit similar to that of FIG. 8.

### Preferred Embodiment 4

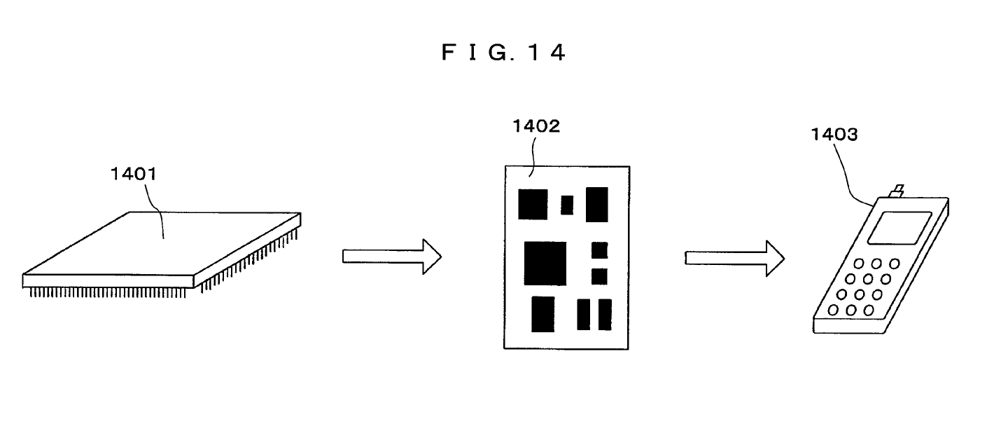

FIG. 14 is a schematic illustration of a communication device incorporating the reconfigurable circuit according to the present invention. A mobile telephone 1403 comprises a system LSI 1401 on a printed-circuit board 1402 provided therein as an application signal processing LSI. The system LSI 1401 is a semiconductor integrated circuit comprising the reconfigurable circuit according to the present invention.

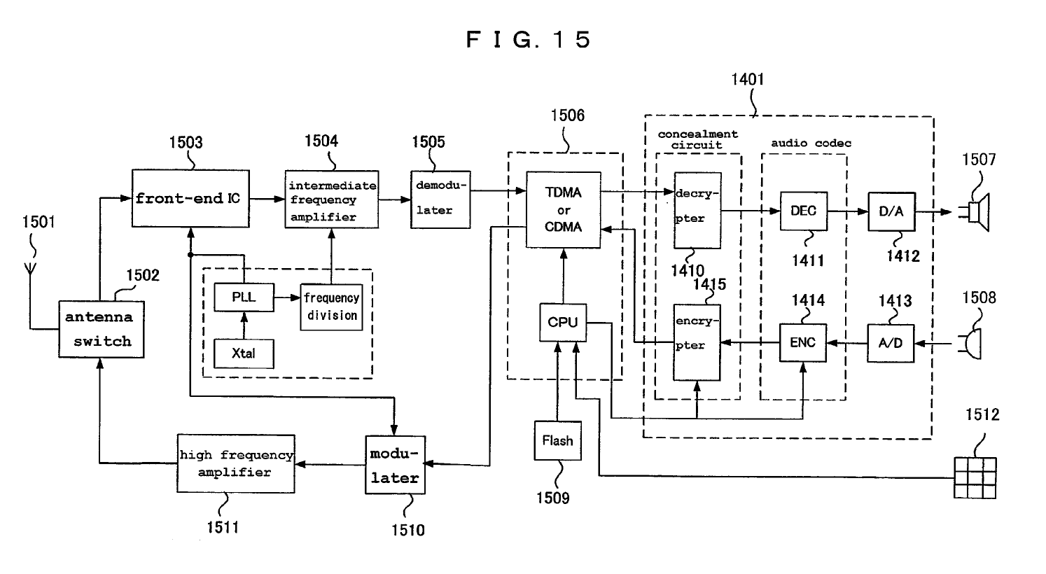

FIG. 15 is a block diagram illustrating signal processing of the whole communication device comprising the reconfigurable circuit according to the present invention. The communication device comprises an antenna unit 1501, an antenna switching circuit 1502 for switching between transmission and reception, a front-end IC 1503 operating as a front-end processor for selecting an electric wave having a targeted frequency from received electric waves, an intermediate frequency amplifying circuit 1504 for converting an output of the front-end IC 1503 into an intermediate frequency signal and amplifying the resulting signal, a demodulator 1505 for retrieving digital data from the intermediate frequency signal, a system LSI 1506 operating as a digital baseband processor in TDMA or CDMA transmission and reception and provided with a CPU for controlling all the signal processes, a system LSI 1401 for processing an application digital signal, a speaker 1507 for outputting audio, a microphone 1508 for converting the audio into an electrical signal (analog signal), a flash memory 1509 in which a program for operating the system LSI 1506 is stored, a modulating circuit 1510 for modulating an output signal which was subjected to digital base band processing, a high frequency amplifier 1511 for superposing the modulated signal on carrier wave and outputting the resulting signal, and a push dial 1512 to which such information as a telephone number is inputted and from which the inputted information is transmitted to the CPU.

The system LSI 1401 comprises an decrypting circuit block (decrypting device) 1410, an audio decoding circuit block (decoding device) 1411 for decompressing compressed digital audio data outputted from the decrypting circuit block 1410, a D/A conversion circuit block (D/A converter) 1412 for converting the decompressed digital audio data outputted from the audio decoding circuit block 1411 into an analog audio signal, a A/D conversion circuit block (A/D converter) 1413 for converting the analog audio signal into digital audio data, an audio encoding circuit block (encoding device) 1414 for compressing the digital audio data, and an encrypting circuit block (encrypting device) 1415. The reconfigurable circuit according to the present invention constitutes the decrypting circuit block 1410, which comprises a function of modifying its circuit architecture in a time-sharing manner. The audio decoding circuit block 1411 decompresses the compressed digital audio data outputted from the decrypting circuit block 1410. The reconfigurable circuit according to the present invention constitutes the decrypting circuit block 1415, which comprises a function of modifying its circuit architecture in a time-sharing manner. The encrypting circuit block 1415 encrypts the compressed digital audio data according to different modes in a time-sharing manner. The system LSI 1401 may include other functional blocks, and a part of it may be provided with a separate chip. A novel integration technology, which is possibly developed in the future, may be used in the system LSI 1401.

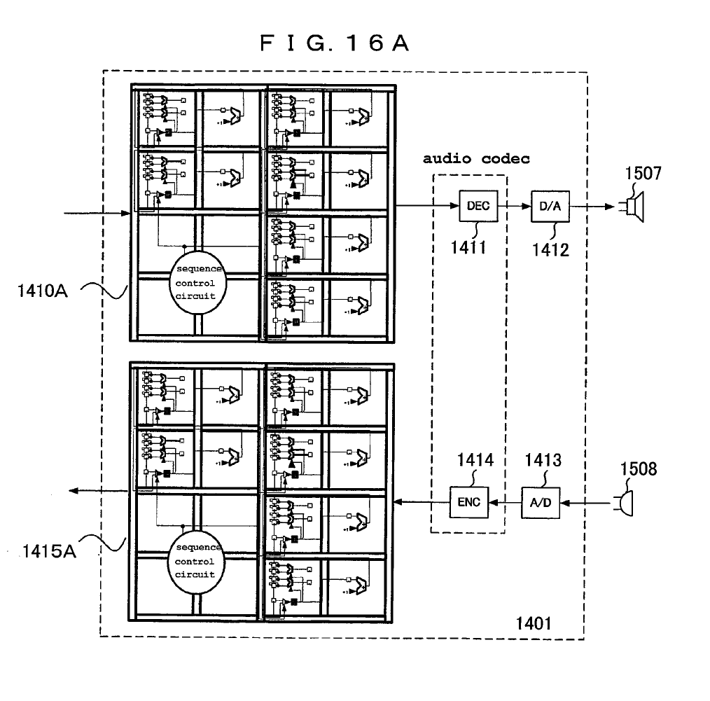

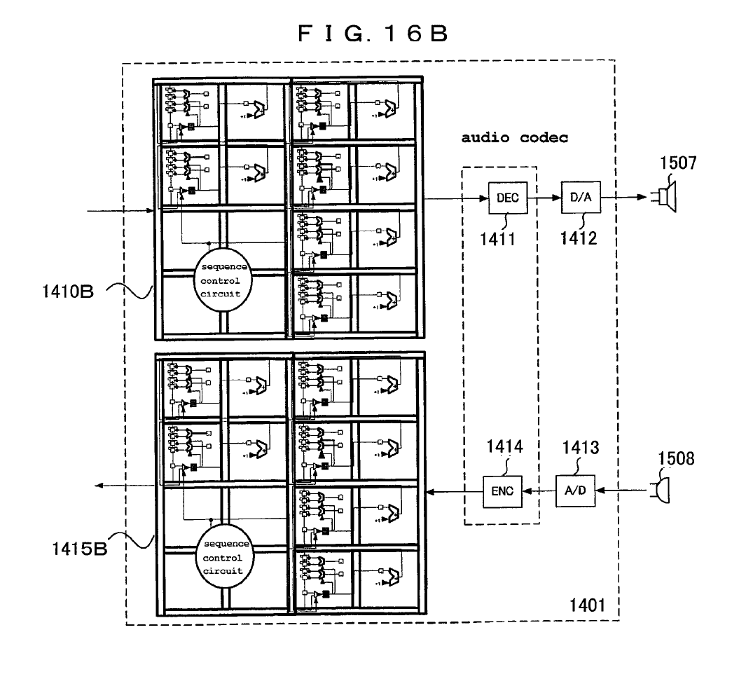

An operation of the system LSI 1401 is described referring to FIGS. 16A and 16B. As illustrated in FIG. 16A, first, the decrypting circuit block 1410, which is a constitutive element unique to the communication device, is mapped into the reconfigurable circuit according to the present invention. As a result, the decrypting circuit block 1410 constitutes a first decrypting circuit block 1410A. Then, an application digital signal is decoded by the first decrypting circuit block 1410A. The decrypting result, which is compressed digital audio data, is audio-decoded by the audio decoding circuit block 1411, and the decoding result thereby obtained is converted into an analog audio signal by the D/A converting circuit 1412. The converted analog signal is outputted to the speaker 1507.

The analog audio signal inputted to the microphone is converted into digital audio data by the A/D converting circuit 1413 and compressed by the audio encoding circuit 1414. At the time, the encrypting circuit block 1415 of the communication device is mapped into the reconfigurable circuit, so that the encrypting circuit block 1415 constitutes a first encrypting circuit block 1415A. Then, the application digital signal is encrypted by the first encrypting circuit block 1415A.

When a unit time (for example, 1 second) passed after the encrypting or decrypting process described so far is completed, in the first encrypting circuit block 1415A and the first decrypting circuit block 1410A mapped into the reconfigurable circuit, configuration data of their calculation elements is changed by calculation elements adjacent thereto. More specifically, logical operations (for example, Ex-OR) in the first decrypting circuit block 1410A and the first encrypting circuit block 1415A are exchanged for different logic operations (for example, AND or OR).

Accordingly, as illustrated in FIG. 16B, the first decrypting circuit block 1410A and the first encrypting circuit block 1415A, whose functions have been thereby modified, respectively constitute a second decrypting circuit block 1410B and a second encrypting circuit block 1415B which can encrypt and decrypt data according to different modes. Therefore, the analog audio signal is converted into digital audio data by the A/D converting circuit 1413, and the resulting digital audio data is compressed by the audio encoding circuit 1414 and then encrypted by the second encrypting circuit block 1415B according to an encryption mode different to the one employed when mapped into the reconfigurable circuit according to the present invention. The digital audio data is, therefore, converted into a digital application signal different to the one described earlier. The digital application signal received through the digital base band processing is decoded into digital audio data compressed by the second decrypting circuit block 1410B having an decryption mode different to the one employed when mapped by the reconfigurable circuit according to the present invention. The decoded digital audio data is decompressed by the audio decoding circuit 1411 and then converted into an analog audio signal by the D/A converting circuit 1412. The analog audio signal is converted into audio by the speaker 1507.

When the encrypting circuit block and the decrypting circuit block are thus modified for each unit time, encryption having an extremely high level of concealment can be provided to the audio signal. With regard to the encrypting circuit block and the decrypting circuit block, they can be also provided in a base station and the reconfigurable circuit according to the present invention can be similarly provided on these circuit blocks.

What the base station and the communication device (terminal) need to retain is only the configuration data of the first encrypting circuit block and the first decrypting circuit block. The configuration data is the data which only the base station and the communication device can know. Even if any other communication device received the encrypted digital application signal, it can not decode the encrypted compressed digital audio signal for listening to it because the configuration data is different. Therefore, a communication system having an extremely high level of concealment can be provided. Though the description was given about a mobile telephone by way of example, the present invention can also be applied to STB, storage/reproduction devices, digital televisions, and encrypting circuits loaded in in-vehicle devices.

### INDUSTRIAL APPLICABILITY

In a reconfigurable circuit according to the present invention, a predetermined bit of configuration data stored in a configuration memory of a first calculation element is updated by another calculation element provided therein. Accordingly, functions of the first calculation element can be modified without repeating configuration. When the capability mentioned above is applied to a test, therefore, a testing time can be effectively reduced. The present invention is useful as a reconfigurable circuit comprising a plurality of calculation elements and a plurality of wiring switches connecting the calculation element.

What is claimed is:

1. A reconfigurable circuit comprising:
a plurality of calculation elements including a first calculation element and a second calculation element; and
a first configuration memory provided in the first calculation element for storing first configuration data, wherein
output data of the first configuration memory is inputted to the second calculation element.

2. The reconfigurable circuit as claimed in claim 1, wherein
the output data includes the first configuration data, and the second calculation element updates a predetermined bit of the first configuration data included in the output data.

3. The reconfigurable circuit as claimed in claim 2, wherein
the first configuration data in which the predetermined bit is updated by the second calculation element is inputted to the first configuration memory, so that a predetermined bit of the first configuration data stored in the first configuration memory is changed.

4. The reconfigurable circuit as claimed in claim 2, further comprising:
a third calculation element; and
a second configuration memory provided in the third calculation element for storing second configuration data, wherein
the first configuration data in which the predetermined bit is updated by the second calculation element is inputted to the second configuration memory, so that a predetermined bit of the second configuration data stored in the second configuration memory is changed.

5. The reconfigurable circuit as claimed in claim 4, further comprising a fourth calculation element, wherein
the fourth calculation element updates a predetermined bit of the second configuration data stored in the second configuration memory and then inputs the updated second configuration data to the first configuration memory.

6. A method for modifying functions of a reconfigurable circuit comprising a plurality of calculation elements including a first calculation element provided with a first configuration memory for storing configuration data and a second calculation element, including steps of:
configuring the reconfigurable circuit;
executing an application operation in the reconfigurable circuit;
updating a predetermined bit of the configuration data stored in the first configuration memory using the second calculation element; and
changing a predetermined bit of the configuration data stored in the first configuration memory by inputting an update result obtained by the second calculation element to the first configuration memory.

7. A method for modifying functions of a reconfigurable circuit comprising a plurality of calculation elements including a first calculation element provided with a first configuration memory for storing first configuration data, a second calculation element, and a third calculation element provided with a second configuration memory for storing a second configuration data, including steps of:
configuring the reconfigurable circuit;
executing an application operation in the reconfigurable circuit;
updating a predetermined bit of the first configuration data stored in the first configuration memory using the second calculation element; and
changing a predetermined bit of the second configuration data stored in the second configuration memory by inputting an update result obtained by the second calculation element to the second configuration memory.

8. A method for modifying functions of a reconfigurable circuit comprising a plurality of calculation elements including a first calculation element provided with a first configuration memory for storing first configuration data, a second calculation element, a third calculation element provided with a second configuration memory for storing second configuration data, and a fourth calculation element, including steps of:
configuring the reconfigurable circuit;
executing an application operation in the reconfigurable circuit;
updating a predetermined bit of the first configuration data stored in the first configuration memory using the second calculation element;
updating a predetermined bit of the second configuration data stored in the second configuration memory using the fourth calculation element;
changing a predetermined bit of the second configuration data stored in the second configuration memory by inputting an update result obtained by the second calculation element to the second configuration memory; and
changing a predetermined bit of the first configuration data stored in the first configuration memory by inputting an update result obtained by the fourth calculation element to the first configuration memory.

9. A communication device for transmitting and receiving an electric wave on which a digital signal encrypted in such a way that modes are shifted in a time-sharing manner is superposed, comprising:
an antenna unit for transmitting or receiving the electric wave;
a front-end processor for synchronizing with an electric wave having a predetermined frequency received by the antenna unit and outputting the electric wave having a predetermined frequency;
a demodulator for outputting a first digital signal from the electric wave having a predetermined frequency;
a digital baseband processor for generating a first application digital signal after providing a receiving-end digital baseband processing to the first digital signal outputted from the demodulator;
a decrypting unit for outputting a compressed first digital data after decrypting the first application digital signal outputted from the digital baseband processor;
a decoder for decompressing the compressed first digital data outputted from the decrypting unit;
a D/A converter for converting the decompressed first digital data outputted from the decoder into a first analog signal;
an A/D converter for receiving a second analog signal and converting the second analog signal into a second digital data;
an encoder for compressing the second digital data outputted from the A/D converter;
an encrypting unit for generating a second application digital signal after encrypting the compressed second digital data outputted from the encoder in such a way that modes are shifted in a time-sharing manner;
a modulator for generating a second digital signal by providing transmitting-end digital baseband processing to the second application digital signal outputted from the encrypting unit using the digital baseband processor, the modulator further generating a carrier wave signal by superposing the generated second digital signal on carrier wave for transmission; and
a high frequency amplifier for amplifying the carrier wave signal generated by the modulator, wherein
the decrypting unit is constituted by the reconfigurable circuit recited in claim 2, so that the circuit architecture thereof shifts in a time-sharing manner, and
the encrypting unit is constituted by the reconfigurable circuit recited in claim 2, so that the circuit architecture thereof shifts in a time-sharing manner.
